(19) United States
(12) Patent Application Publication
(10) Pub. No.: US 2006/0197918 A1
(43) Pub. Date: Sep. 7, 2006

(54) Projector and projector lamp control

(75) Inventor: Daisuke Kobayashi, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/365,693

(22) Filed: Mar. 2, 2006

(30) Foreign Application Priority Data
Mar. 4, 2005 (JP) 2005-061432

(51) Int. Cl. G03B 21/18

(52) U.S. Cl. 353/57

(57) ABSTRACT

It is determined whether or not an optical disk is loaded on an optical disk reproducing unit which reproduces video data recorded on an optical disk, and in the case where the optical disk is loaded, a power supply of a lamp is controlled so that a predetermined brightness is achieved. In the case where no optical disk is loaded on the optical disk reproducing unit, a power supply of a light source is controlled so that a brightness becomes smaller than the predetermined brightness.

### CROSS-REFERENCE TO RELATED APPLICATIONS

This application is based upon and claims the benefit of priority from prior Japanese Patent Application No. 2005-061432, filed Mar. 4, 2005, the entire contents of which are incorporated herein by reference.

### BACKGROUND

1. Field

One embodiment of the invention relates to the present invention relates to lamp control for a projector which projects images on a screen.

2. Description of the Related Art

In recent years, needs of projecting images on more brightly and more subtly on a large screen have increased, and demand of projectors and household LCD TVs, etc. has been rapidly growing. In addition, high-resolution digital broadcasting has begun to be popularized, and needs of higher resolution and bigger screen TVs have been increased year after year.

It is disclosed by, for example, as needs of higher resolution and bigger screens are enhanced in this way, development races of projectors which use various types of image display devices have been deployed from institutional use to household use in an effort to achieve still bigger and still brighter screens.

In general, since projectors project images using high brightness lamps, measures for heat generation of lamps become essential. In Jpn. Pat. Appln. KOKAI Publication No. 2003-005147, a technique to lower lamp brightness and lower a rotating speed of a cooling fan when image signals are not entered is disclosed.

More recently, projectors that load an optical disk reproducing device for reproducing DVD and other optical disks have been developed. These projectors can directly reproduce DVD video software, for example, movie pictures, and allow people to view and listen to them.

However, in these projectors, lamps continue to emit light at high brightness, for example, even in the case where no optical disk is loaded on the optical disk reproducing device. In such a case, an electric power is wasted and the life of lamp is shortened.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration of a projector according to one embodiment of the present invention according to a first embodiment of the invention;

FIG. 2 is a block diagram showing a configuration example of an optical disk reproducing device 20 according to the first embodiment of the invention;

FIG. 3 is a flow chart showing an operation of the optical disk reproducing device 20 when a disk tray is opened and closed according to the first embodiment of the invention;

FIG. 4 is a flow chart showing a first embodiment of lamp and cooling fan control when the disk tray is opened and closed according to the first embodiment of the invention;

FIG. 5 is a flow chart showing a second embodiment of lamp and cooling fan control when the disk tray is opened and closed according to the first embodiment of the invention; and

FIG. 6 is a flow chart showing a third embodiment of lamp and cooling fan control when the disk tray is opened and closed according to a second embodiment of the invention.

### DETAILED DESCRIPTION

Various embodiments according to the invention will be described hereinafter with reference to the accompanying drawings. In general, according to one embodiment of the invention, referring now to drawings, embodiments of the present invention will be described in detail as follows. In the embodiments shown as follows, examples of a front projection projector will be described, but the present invention may be also applied to a rear projection projector.

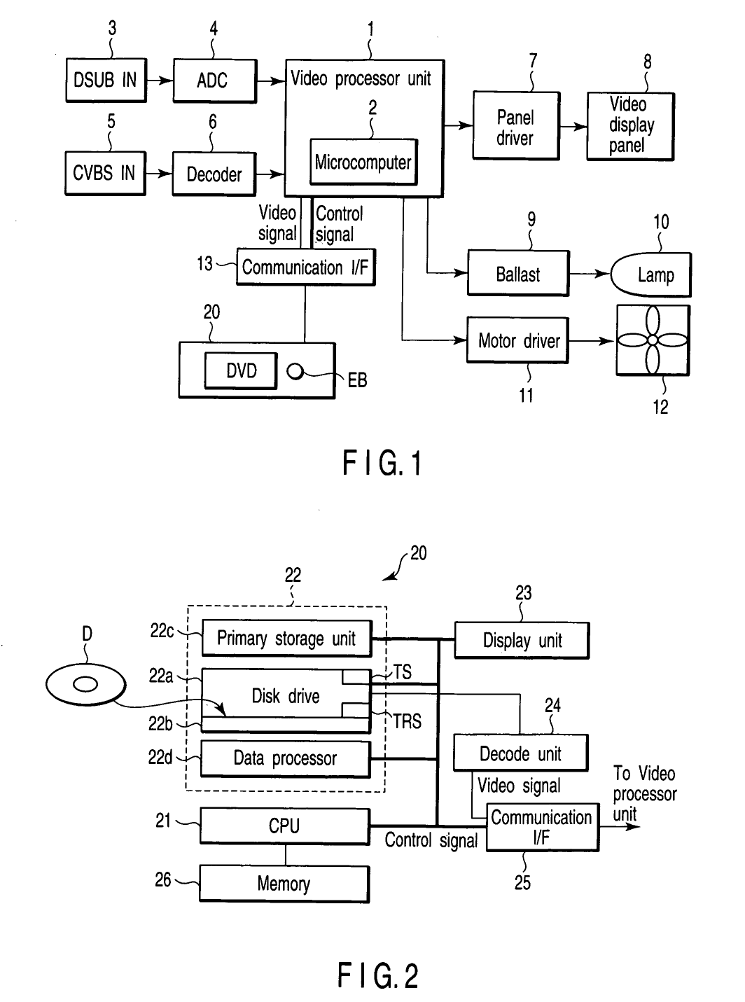

According to an embodiment, FIG. 1 shows a block diagram showing a configuration of a projector according to one embodiment of the present invention.

Analog video signals are entered to a DSUB terminal 3 from a device such as a personal computer (PC), and the video signals are converted into digital form video data by an A/D converter 4 and supplied to a video processor unit 1. Digital form video data is entered to a CVBS terminal 5 from a device such as a digital broadcasting tuner, and the video data is decoded by a decoder 6 and supplied to the video processor unit 1.

The video processor unit 1 provides digital video processing to the entered video data under the control of a microcomputer 2 and supplies the processed video data to a panel driver 7. The panel driver 7 converts the entered video data into analog video signals and presents to a video display panel 8 of the subsequent stage, and at the same time, generates vertical synchronizing signals and horizontal synchronizing signals, etc. and presents to the display panel 8 in order to enable display by the display panel 8. The video display panel 8 is, for example, a liquid crystal display panel which displays images in conformity to the entered video signals, and vertical and horizontal synchronizing signals.

A ballast 9 is a variable voltage power supply, and drives a lamp 10 as a power source under the control of the microcomputer 2. Images displayed on the display panel 8 are projected on a screen (not shown) by the lamp 10. A motor driver 11 rotates and drives a fan 12 under the control of the microcomputer 2.

The projector according to the present invention has an optical disk reproducing unit 20 loaded thereon. The optical disk reproducing unit 20 is a so-called DVD (Digital Versatile Disk) player, which reproduces information recorded on an optical disk such as DVD and transmits the reproduced information to the video processor unit 1 via a communication interface unit 13.

FIG. 2 is a block diagram showing a configuration example of the optical disk reproducing unit 20.

The optical disk reproducing unit 20 includes an information reproducing unit 22 which reproduces data recorded on a disk D in response to reproducing directions, a CPU 21 which controls reproduction by the information reproducing unit 22 and operations of each unit described as follows, and others.

The information reproducing unit 22 includes, for example, a disk drive unit 22a which can reproduce data recorded on a disk D manufactured in compliance with the DVD standard, a temporary recording unit 22b which functions as a buffering memory that can temporarily hold a predetermined amount of data reproduced from the disk D set to the disk drive unit 22a, and a data processor 22c.

The disk drive unit 22a includes a tray 22b which places a disk D, a tray sensor TRS which detects opening and closing of the tray 22b, an eject button EB (see FIG. 1), and a temperature sensor TS which measures an internal temperature of the disk drive unit 22a. Pressing the eject button EB with the tray 22b placed draws out the tray 22b from the disk drive unit 22a. In addition, pressing the eject button EB with the tray 22b drawn out places the tray 22b into the disk drive unit 22a.

A data processor 22d imports reproduced signals of the disk D via the disk drive unit 22a under the control of the CPU 21, provides processing such as error correction and supplies the processed signals to a decode unit 24. The decode unit 24 decodes (expands) the video data entered from the disk drive unit 22a. The data decoded by the decode unit 24 is transmitted to the microcomputer 2 (see FIG. 1) via a communication interface unit 25 which communicates in accordance with, for example, a UART protocol.

To the CPU 21, a display unit 23 is connected, which indicates the operating state of the communication interface unit 25 and the DVD reproducing device 20. The CPU 21 controls data reproduction to the disk D, transmits the reproduced data by use of a communication control unit 5, display operation by use of the display unit 23, and the like in compliance with a control program stored in a memory 26.

Next, discussion will be made on lamp control when a disk tray is opened and closed in accordance with the present invention.

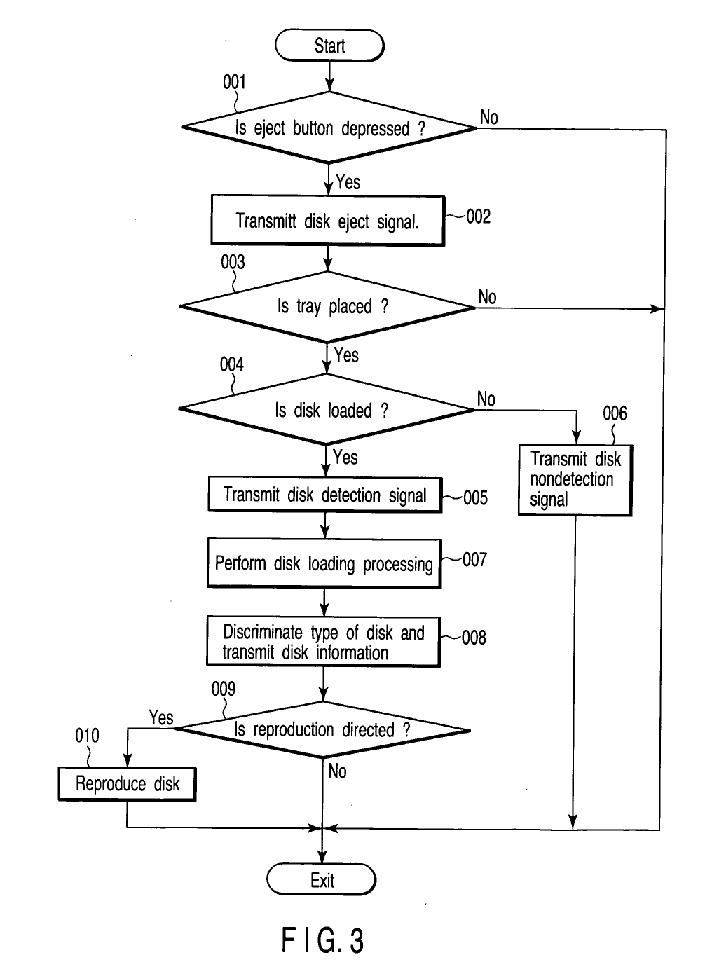

FIG. 3 is a flow chart showing an operation of the optical disk reproducing device 20 when a disk tray is opened and closed. The CPU 21 of the optical disk reproducing unit 20 detects when the eject button EB is depressed by a user (Yes in block 001), and transmits disk eject signals to the microcomputer 2 of the image processing unit 1 via the communication interface unit 25 (block 002).

In the predetermined time after the depression of the eject button EB is detected, the CPU 21 determines whether or not the tray 22b is placed by using the tray sensor TRS (block 003). In the case where the tray 22b is placed, the CPU 21 emits a reproduction laser beam and determines whether or not the disk D is loaded on the basis of the reflected light (block 004). In the case where the disk D is loaded, the CPU 21 transmits disk detection signals to the microcomputer 2 (block 005), and in the case where no disk D is loaded, the CPU 21 transmits disk non-detection signals to the microcomputer 2 (block 006).

As is the case of block 005, after detecting disk detection signals, the CPU 21 rotates the disk D, carries out disk loading processing, and reads control information of the disk D (block 007). The CPU 21 identifies the type of the disk from the control information, and transmits the identification results to the microcomputer 2 as disk information (block 008).

Thereafter, the CPU 21 reproduces the data recorded on the disk D when it receives disk reproduction directions from a user via an operation unit (not shown) (block 010).

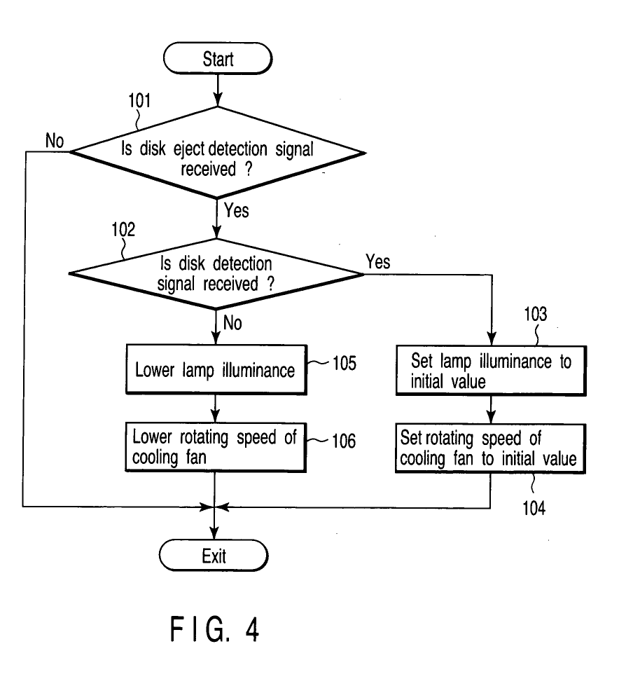

FIG. 4 is a flow chart showing a first embodiment of lamp and cooling fan control when the disk tray is opened and closed.

When the microcomputer 2 receives disk eject signals (see block 002 of FIG. 3) from the CPU 21 as is the case of block 101 and receives disk detection signals (see block 005 of FIG. 3) as is the case of block 102, the microcomputer 2 controls the ballast 9 and sets the brightness of the lamp 10 to the initial value (block 103). This allows the lamp 10 to emit light at the rated electric power. Furthermore, the microcomputer 2 controls the motor driver 11 to set the rotating speed of the cooling fan 12 to the initial value (block 104). This causes the cooling fan 12 to rotate at the rated rotating speed.

Upon receiving disk non-detection signals (No in block 102), the microcomputer 2 controls the ballast 9 and lowers the brightness of the lamp 10 from the brightness of the initial value (block 105). That is, the microcomputer 2 drives the lamp to achieve the brightness lower than the initial value. Furthermore, the microcomputer 2 controls the motor driver 11 and lowers the rotating speed of the cooling fan 12 (block 106). That is, the microcomputer drives the cooling fan so that the rotating speed is lower than the initial value.

As described above, according to the present embodiment, the brightness of the lamp 10 and the rotating speed of the fan 12 are controlled in accordance with disk detection signals when the disk tray 22b is inserted into the disk drive unit 22a, so that energy-saving and silent effects can be obtained and extended lamp life span can be achieved.

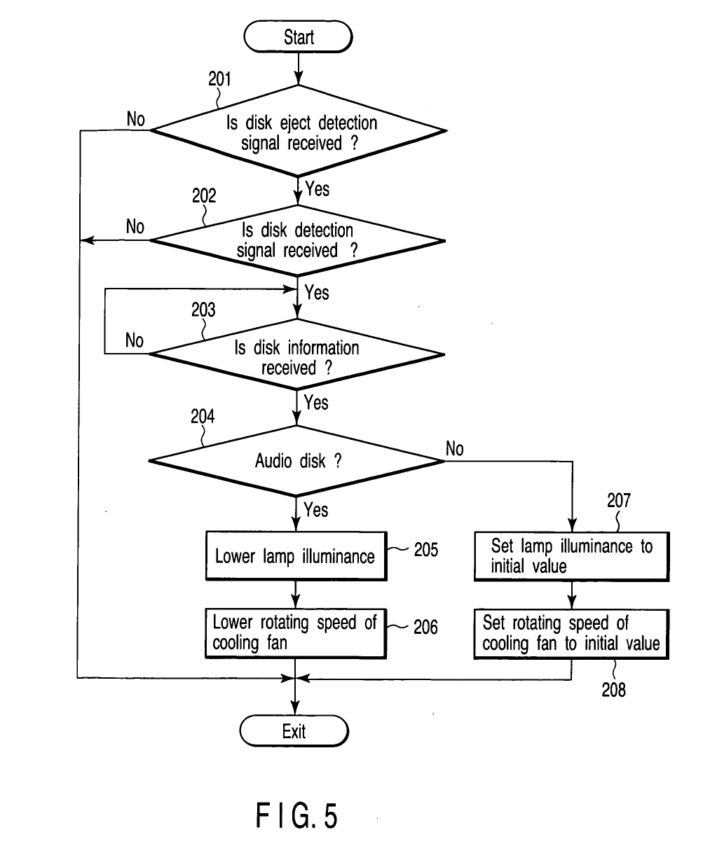

FIG. 5 is a flow chart showing a second embodiment of lamp and cooling fan control when the disk tray is opened and closed. In this embodiment, the lamp and the cooling fan are controlled in accordance with the type of disks.

When the microcomputer 2 receives disk eject signals (see block 002 of FIG. 3) from the CPU 21, receives disk eject signals (see block 002 of FIG. 3) from the CPU 21 as is the case of block 201, and receives disk information that indicates the type of disks (see block 008 of FIG. 3) as is the case of block 202, the microcomputer 2 controls the brightness of the lamp 10 in accordance with the type of disks (VCD, Music CD, DVD Audio, DVD Video, etc.) and also controls the rotating speed of the fan 12. That is, in the case where the loaded disk D is an audio-dedicated disk (Yes in block 204), the microcomputer 2 controls the ballast 9 and lowers the brightness of the lamp 10 (block 205). More specifically, the microcomputer 2 drives the lamp so that the brightness becomes lower than the initial value. Furthermore, the microcomputer 2 controls the motor driver 11 to lower the rotating speed of the cooling fan 12 (block 206). That is, the microcomputer 2 drives the cooling fan so that the rotating speed becomes lower than the initial value. In the case where the loaded disk D is a disk of the type that includes video data (No in block 204), the microcomputer 2 controls the ballast 9 to set the brightness of the lamp 10 to the initial value (Block 207). Furthermore, the microcomputer 2 controls the motor driver 11 to set the rotating speed of the cooling fan 12 to the initial value (Block 208).

As described above, according to the second embodiment, the brightness of the lamp 10 and the rotating speed of the fan 12 are controlled in accordance with the type of optical disks loaded on the device, so that energy-saving and silent effects can be obtained and extended lamp life span can be achieved.

Now, a third embodiment of the present invention will be explained.

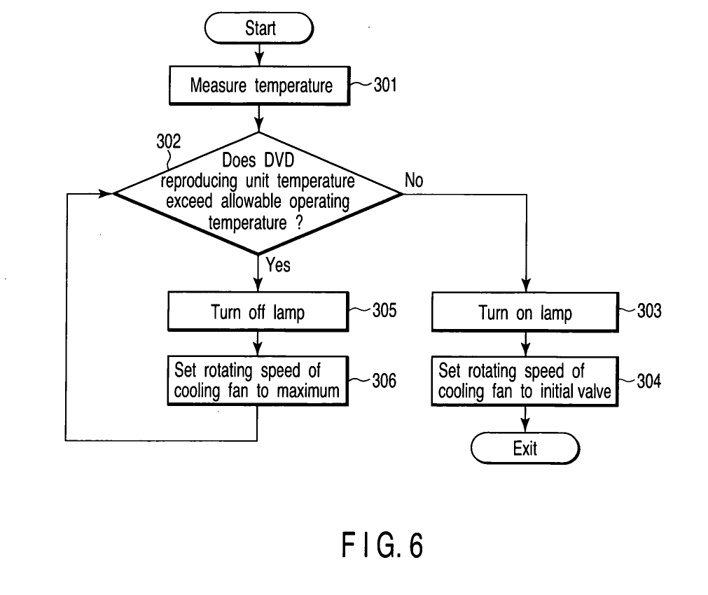

FIG. 6 is a flow chart showing the third embodiment of lamp and cooling fan control when the disk tray is opened and closed. In this embodiment, the brightness of the lamp is controlled in accordance with the temperature condition of the optical disk reproducing unit.

The CPU 21 of the optical disk reproducing unit 20 measures a temperature of the disk drive unit 22a by using a temperature sensor TS mounted to the disk drive unit 22a, and transmits the measured temperature value to the microcomputer 2 of the image processing unit 1 (Block 301).

When the microcomputer 2 receives the measured temperature value from the optical disk reproducing unit 20, the microcomputer 2 determines whether or not the measured temperature value exceeds an allowable operating temperature (block 302). In the case where the measured temperature value exceeds the allowable operating temperature, the microcomputer 2 turns off the lamp 10 (block 305). Further, the microcomputer 2 sets the rotating speed of the cooling fan to the maximum allowable rotating speed (block 306). For example, in the case where the measured temperature value exceeds the allowable operating temperature in the standby state, the microcomputer 2 carries out control not to turn on the lamp 10.

The reason why the temperature of the disk drive unit 22a is measured in this event is that the rated operating temperature is generally lower than that of conventional projectors including no disk drive unit because the disk drive unit 22a has precision optical parts such as an optical pickup head incorporated. That is, the allowable operating temperature in block 302 is the allowable operating temperature of the disk drive unit 22a, and it is, for example, 70° C. Needless to say, in addition to the disk drive unit 22a, the operating temperature of other places such as the display panel 8, etc. may be confirmed.

In the case where the measured temperature value does not exceed the allowable operating temperature (No in block 302), the microcomputer 2 controls the ballast 9 so that the lamp 10 is turned on, that is, the brightness of the lamp 10 becomes the initial value. Furthermore, the microcomputer 2 controls the motor driver 11 to set the rotating speed of the cooling fan 12 to the initial value (block 304).

As described above, according to the present embodiment, the lamp is controlled in accordance with the temperature condition of the disk drive and the like, so that a stabilized operation of electronic devices and extended lamp life span can be achieved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A projector which drives a display panel by video signals entered and displays images displayed in a display device by projecting them to a screen, the projector comprising:
a display panel which displays images;
a light source to project the images displayed on the display panel;
a power supply which supplies an electric power to the light source;
a cooling section which cools the light source by use of a fan;
a motor driver which drives the fan;
an optical disk reproducing section which reproduces video data recorded on an optical disk;
a determining section which determines whether or not an optical disk is loaded on the optical disk reproducing section;
a first control section which controls the power supply of the light source so that a predetermined brightness of the light source is obtained in a case where an optical disk is loaded on the optical disk reproducing section; and
a second control section which controls the power supply of the light source so that the brightness is smaller than the predetermined brightness in a case where no optical disk is loaded on the optical disk reproducing section.

2. The projector according to claim 1, wherein the second control section controls the power supply of the light source so that the light source is turned off in the case where no optical disk is loaded on the optical disk reproducing section.

3. The projector according to claim 1, wherein
the first control section controls the motor driver so that the fan of the cooling section rotates at a predetermined rotating speed in the case where an optical disk is loaded on the optical disk reproducing section, and
the second control section controls the motor driver so that the fan of the cooling section rotates at a rotating speed lower than the predetermined rotating speed in the case where no optical disk is loaded on the optical disk reproducing section.

4. The projector according to claim 1, wherein
the optical disk reproducing section includes identifying section which identifies a type of an optical disk loaded on the optical disk reproducing section, and
the first control section controls the power supply of the power source so that a brightness achieves a first brightness in the case where the loaded optical disk is an optical disk of a type that includes video data, and controls the power supply of the light source so that a brightness becomes a second brightness which is smaller than the first brightness in the case where the loaded optical disk is an audio-dedicated disk.

5. The projector according to claims 1, wherein the optical disk reproducing section includes a measuring section which measures a temperature of the optical disk reproducing section, the projector further comprising:
a third control section which controls the power supply of the light source so that the light source turn off in the case where the temperature exceeds an allowable operating temperature of the optical disk reproducing section.

6. The projector according to claim 5, wherein the third control section controls the motor driver so that the fan of the cooling section rotates at a rotating speed higher than the predetermined rotating speed in a case where the temperature exceeds the allowable operating temperature of the optical disk reproducing section.

7. A projector which drives a display panel by video signals entered and displays images displayed in a display device by projecting them to a screen, the projector comprising:
a display panel which displays images;
a light source to project the images displayed on the display panel;
a power supply which supplies an electric power to the light source;
a cooling section which cools the light source by use of a fan;
a motor driver which drives the fan;
an optical disk reproducing section which reproduces video data recorded on an optical disk;
an identifying section which identifies the type of an optical disk loaded on the optical disk reproducing section;
a first control section which controls the power supply of the light source so that a brightness of the light source becomes a first brightness in a case where the optical disk loaded on the optical disk reproducing section is an optical disk of a type that includes video data; and
a second control section which controls the power supply of the light source so that a brightness of the light source becomes a second brightness which is smaller than the first brightness in a case where the loaded optical disk is an audio-dedicated disk.

8. The projector according to claim 7, wherein
the first control section controls the motor driver so that the fan of the cooling section rotates at a predetermined rotating speed in a case where the optical disk loaded on the optical disk reproducing section is an optical disk of a type that includes video data, and
the second control section controls the motor driver so that the fan of the cooling section rotates at a rotating speed lower than the predetermined rotating speed in a case where the loaded optical disk is an audio-dedicated disk.

9. The projector according to claim 8, wherein the optical disk reproducing section includes measuring section which measures a temperature of the optical disk reproducing section, the projector further comprising:
a third control section which controls the power supply of the light source so that the light source turn off in a case where the temperature exceeds an allowable operating temperature of the optical disk reproducing section.

10. The projector according to claim 9, wherein the third control section controls the motor driver so that the fan of the cooling section rotates at a rotating speed higher than the predetermined rotating speed in the case where the temperature exceeds the allowable operating temperature of the optical disk reproducing section.

11. A method of controlling a lamp of a projector which drives a display panel by video signals entered and displays images displayed on a display device by projecting them to a screen by the lamp, the method comprising:
determining whether or not an optical disk is loaded on an optical disk reproducing device which reproduces video data recorded on the optical disk;
controlling the power supply of the lamp so that a brightness becomes a predetermined brightness in a case where an optical disk is loaded on the optical disk reproducing device; and
controlling the power supply of the lamp so that a brightness becomes smaller than the predetermined brightness in a case where no optical disk is loaded on the optical disk reproducing section.
